(19) United States
(12) Patent Application Publication
(10) Pub. No.: US 2013/0298708 A1
(43) Pub. Date: Nov. 14, 2013

(54) POWER TRANSMISSION DEVICE FOR VEHICLE

(71) Applicants: Akira Takeshita, Ryugasaki-shi (JP); Kenji Uezono, Ushiku-shi (JP); Masaki Suzuki, Kasumigaura-shi (JP); Naofumi Sogo, Akashi-shi (JP); Chiharu Ueda, Kakogawa-shi (JP)

(72) Inventors: Akira Takeshita, Ryugasaki-shi (JP); Kenji Uezono, Ushiku-shi (JP); Masaki Suzuki, Kasumigaura-shi (JP); Naofumi Sogo, Akashi-shi (JP); Chiharu Ueda, Kakogawa-shi (JP)

(73) Assignee: HITACHI CONSTRUCTION MACHINERY CO., LTD., Tokyo (JP)

(21) Appl. No.: 13/877,376

(22) PCT Filed: Jan. 25, 2012
(86) PCT No.: PCT/JP2012/051535

§ 371 Date: Apr. 2, 2013

(30) Foreign Application Priority Data
Feb. 2, 2011 (JP) 2011-020622

(51) Int. Cl. F16H 3/08

(52) U.S. Cl. CPC F16H 3/08
USPC 74/331

(57) ABSTRACT

A power transmission device for a vehicle includes a casing mounted on a vehicle, a rotational shaft supported in the casing and rotated by an engine, first and second speed changing shafts, supported in the casing and changing a speed of rotation of the rotational shaft, a first speed clutch mechanism and a second speed clutch mechanism provided between the rotational shaft and the first and second speed changing shafts, respectively, and an output shaft outputting rotation of one speed changing shaft selected by each of the clutch mechanisms. A first brake device applying a braking force to the first speed changing shaft and a second brake device applying the braking force to the second speed changing shaft are provided in the casing.

### TECHNICAL FIELD

The present invention relates to a power transmission device for a vehicle mounted on a working vehicle such as a wheel loader, a wheel type excavator or the like and transmitting rotation of a prime mover to an output shaft for traveling.

### BACKGROUND ART

In general, a wheel type working vehicle represented by a wheel loader, a wheel type excavator and the like travels on a general road to a work site by rotating and driving wheels. In this case, the wheel type working vehicles include those driving a hydraulic motor by an engine and transmitting the rotation of this hydraulic motor to the wheels and those transmitting the rotation of the engine to the wheels through a torque converter and a power transmission mechanism.

Here, in the working vehicle transmitting the rotation of the engine to the wheels through the torque converter, a power transmission device for a vehicle provided with a speed changing mechanism between the torque converter and an axle is usually provided, and forward traveling, backward traveling, traveling speed and the like of the working vehicle can be switched by this power transmission device for a vehicle.

The power transmission device for a vehicle includes a casing mounted on a vehicle, a rotational shaft rotatably supported in the casing and rotated by a prime mover, a plurality of speed changing shafts juxtaposed in parallel in the casing and rotatably supported, each changing rotation of the rotational shaft to a different rotation number, a clutch mechanism provided between the rotational shaft and each of the speed changing shafts and selectively connecting the rotational shaft and any one of the speed changing shafts, and an output shaft connected to each of the speed changing shafts all the time through a gear and outputting the rotation of the one of the speed changing shafts selected by the clutch mechanism to a wheel of the vehicle body.

Moreover, the above-described power transmission device for a vehicle is provided with a negative brake device (parking brake) for applying a braking force in a state where the working vehicle is parked. This brake device is usually provided singularly between any one of the plurality of speed changing shafts connected to the output shaft all the time through the gear and the casing (See Patent Document 1).

Here, the brake device of the power transmission device for a vehicle usually includes a plurality of fixed-side brake disks and a plurality of rotating-side brake disks by overlapped alternately in the axial direction. Each of the fixed-side brake disks is spline-connected to the casing side so as to become movable in the axial direction and fixed in the rotating direction, while each of the rotating-side brake disks is spline-connected to the speed changing shaft side so as to become movable in the axial direction and to integrally rotate with the speed changing shaft.

If the working vehicle is parked and a brake release pressure (hydraulic pressure) is not supplied, this brake device brings the fixed-side brake disk and the rotating-side brake disk into contact with each other by using a spring force and applies a braking force to the speed changing shaft by a frictional force between the both. On the other hand, if the engine is operated and the working vehicle is traveling, the brake device separates the fixed-side brake disk and the rotating-side brake disk from each other against the spring force by the brake release pressure and releases the braking force acting on the speed changing shaft.

Further, the brake device of the power transmission device for a vehicle does not function only as a parking brake during parking but also functions as an emergency brake which applies a braking force to the working vehicle during traveling in an emergency, for example.

### PRIOR ART DOCUMENT

### Patent Document

Patent Document 1: Japanese Patent Laid-Open No. 2008-57551 A

### SUMMARY OF THE INVENTION

If the size of the working vehicle such as a wheel loader becomes large and the weight of the car body increases, the braking force by a brake device needs to be increased in order to rapidly stop the traveling working vehicle in an emergency.

However, in a conventional art power transmission device for a vehicle, one brake device is provided between one of a plurality of speed changing shafts connected to an output shaft all the time and a casing. Thus, there is a problem that it is difficult to generate a sufficient braking force in an emergency by one brake device.

If the numbers of fixed-side brake disks and rotating-side brake disks constituting the brake device are increased in order to cope with the above problem, for example, adjacent brake disks can easily contact each other during traveling of the working vehicle. As a result, there is nonconformity that smooth rotation of the speed changing shafts is prevented, and moreover, the brake device generates heat. Furthermore, by increasing the numbers of the fixed-side brake disks and the rotating-side brake disks, a dimension in the axial direction of the speed changing shaft becomes larger. As a result, there is a problem that the size of the power transmission device for a vehicle becomes large and a layout when the power transmission device for a vehicle is mounted on a vehicle is limited.

In view of the above-discussed problems with the conventional art, it is an object of the present invention to provide a power transmission device for a vehicle that can apply a large braking force to an output shaft and can suppress generation of heat during traveling of the vehicle.

(1) In order to solve the above-described problems, the present invention is applied to a power transmission device for a vehicle including a casing mounted on a vehicle; a rotational shaft rotatably supported in the casing and rotated by a prime mover mounted on the vehicle; a plurality of speed changing shafts juxtaposed in parallel in the casing and rotatably supported, each changing rotation of the rotational shaft to different rotation numbers; a clutch mechanism provided between the rotational shaft and each of the speed changing shafts and selectively connecting any one of the speed changing shafts and the rotational shaft; and an output shaft connected to each of the speed changing shafts all the time through a gear and outputting the rotation of the one of the speed changing shafts selected by the clutch mechanism to a wheel of the vehicle.

A feature of the present invention is that a plurality of brake devices, each applying a braking force to each of the speed changing shafts, are provided in the casing.

With this arrangement, a braking force from the brake device can be applied to one speed changing shaft connected to the rotational shaft by the clutch mechanism and the other speed changing shafts not connected to the rotational shaft, respectively. Since the braking force acts on the plurality of speed changing shafts from the brake device, respectively, at the same time, a larger braking force can be applied to the output shaft as compared with the case where one brake device is provided between any one of the plurality of speed changing shafts and the casing, for example. As a result, if the brake device of the power transmission device is operated during traveling of a vehicle, the traveling vehicle can be quickly stopped.

Moreover, by providing the brake device at each of the plurality of speed changing shafts, the braking force applied to the output shaft can be increased. Therefore, there is no need to increase the numbers of the fixed-side brake disks and the rotating-side brake disks constituting each brake device, and a sufficient gap can be ensured between each of the fixed-side brake disks and each of the rotating-side brake disks. As a result, contact of the rotating-side brake disk with the fixed-side brake disk during traveling of the vehicle can be suppressed, and heat generation in the brake disk can be suppressed, and in addition, each of the rotating-side brake disks can be smoothly rotated. Therefore, energy loss transmitted to the output shaft can be suppressed, and a rotation output of the prime mover can be efficiently transmitted to the wheels.

Moreover, by keeping the number of the rotating-side brake disks attached to each of the speed changing shafts small, the dimension in the axial direction of each speed changing shaft can be reduced, and configuration of the entire power transmission device can be made compact as compared with the case where a large number of the rotating-side brake disks are attached to one speed changing shaft, for example.

(2) According to the present invention, the plurality of brake devices are configured to be arranged closer to one side in the axial direction with respect to the plurality of speed changing shafts.

With this arrangement, the brake devices can be arranged collectively on the same side in the axial direction of each speed changing shaft. Therefore, when a hydraulic hose for supplying pressurized oil for operation is connected to each of the brake devices, the hydraulic hoses can be set to substantially the same length. As a result, the pressurized oil for operation can be supplied to each of the brake devices substantially simultaneously, and operating timing of each of the brake devices can be coincided to each other.

(3) According to the present invention, either one of the speed changing shafts and the other speed changing shaft are arranged on the both sides sandwiching the output shaft, respectively, in the casing. With this arrangement, the braking force can be applied by using the brake device to the one speed changing shaft and the other speed changing shafts arranged sandwiching the output shaft, simultaneously.

(4) According to the present invention, the casing is formed of a front casing, an intermediate casing located on the rear side of the front casing, and a rear casing located on the rear side of the intermediate casing; the rotational shaft is supported by the intermediate casing and the rear casing; each of the speed changing shafts is located on the lower side of the rotational shaft and supported by the intermediate casing and the rear casing, respectively, so as to oppose each other in the left and right directions; the output shaft is located on the lower side of each of the speed changing shafts and supported by the intermediate casing and the front casing; and each of the brake devices is located on the front end side of each of the speed changing shafts and provided on the front surface of the front casing.

With this configuration, since a large quantity of cooling air can be supplied to each of the brake devices by using traveling wind pressure when the vehicle is traveling, the power transmission device for a vehicle including each of the brake devices can be efficiently cooled.

(5) According to the present invention, each of the brake devices is configured as a negative-type brake which releases braking by supply of pressurized oil to an oil chamber; a hydraulic pump and each of the brake devices are connected to each other through an oil passage, and a brake control valve having a brake release position where the pressurized oil is supplied from a hydraulic pump to the oil chamber of each of the brake devices so as to release the braking force and a brake position where the oil chamber of each of the brake devices is connected to a tank so as to apply the braking force is provided in the middle of the oil passage; and each of the brake devices applies the braking force by the brake control valve to each of the speed changing shafts simultaneously or releases the braking force of each of the speed changing shafts simultaneously.

With this arrangement, when the brake control valve is switched to the brake position, the braking force can be applied from each of the brake devices to each of the speed changing shafts at the same time, and a large braking force obtained by combining the braking forces of the brake devices can be applied to the output shaft. On the other hand, when the brake control valve is switched to the brake release position, the braking force acting from each of the brake devices to each of the speed changing shafts can be released at the same time, and the output shaft can be smoothly rotated.

(6) According to the present invention, the vehicle includes a front vehicle body on which front wheels are provided, a rear vehicle body on which rear wheels are provided and a connecting mechanism which is provided between the front vehicle body and the rear vehicle body and connects the front vehicle body and the rear vehicle body bendably in the left and right directions; and the prime mover is mounted on either one of the front vehicle body and the rear vehicle body, the casing is located between the connecting mechanism and the prime mover on one of the vehicle bodies, and the brake device is configured to be arranged on one side in the axial direction of each of the speed changing shafts oppositely to the connecting mechanism.

With this configuration, a large quantity of cooling air can be supplied to each of the brake devices by using traveling wind pressure during traveling of the vehicle, and the power transmission device for a vehicle including each of the brake devices can be efficiently cooled. Moreover, by bending the front vehicle body and the rear vehicle body around the connecting mechanism, workability when a maintenance work is performed for each of the brake devices arranged oppositely to the connecting mechanism can be improved.

### BRIEF DESCRIPTION OF THE DRAWINGS

FIG. 1 is a front view illustrating a wheel loader on which a power transmission device for a vehicle according to the present invention is mounted.

FIG. 2 is a plan view illustrating the wheel loader in a state where a front vehicle body and a rear vehicle body are bent.

FIG. 3 is a front view illustrating the power transmission device for a vehicle as a single body.

FIG. 4 is a right side view of the power transmission device for a vehicle when seen from arrows IV-IV direction in FIG. 3.

FIG. 5 is a longitudinal sectional view of the power transmission device for a vehicle when seen from arrows V-V direction indicated by a one-dot chain line in FIG. 4.

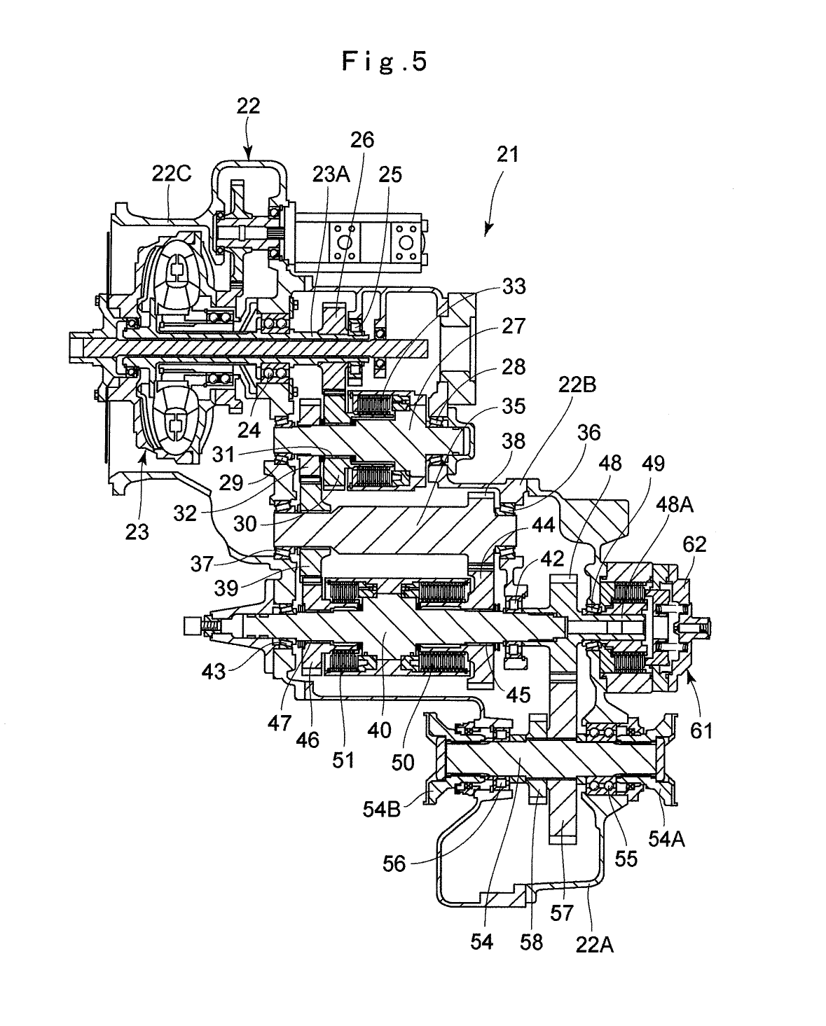

FIG. 6 is an enlarged cross-sectional view of essential portions of first and second speed changing shafts, an output shaft, first and second brake devices and the like when seen from arrows VI-VI direction indicated by a two-dot chain line in FIG. 4.

FIG. 7 is a hydraulic circuit diagram including the first and second brake devices.

### MODE FOR CARRYING OUT THE INVENTION

An embodiment of the power transmission device for a vehicle according to the present invention will be described below in detail by referring to the attached drawings.

In figures, designated at 1 is a wheel loader as a typical example of a wheel type working vehicle. This wheel loader 1 includes a front vehicle body 3 on which left and right front wheels 2 are provided and a rear vehicle body 5 on which left and right rear wheels 4 are provided connected bendably in the left and right directions through a connecting mechanism 6. This wheel loader 1 is configured as an articulate-type working vehicle in which steering is performed by bending of the front vehicle body 3 and the rear vehicle body 5 in the left and right directions.

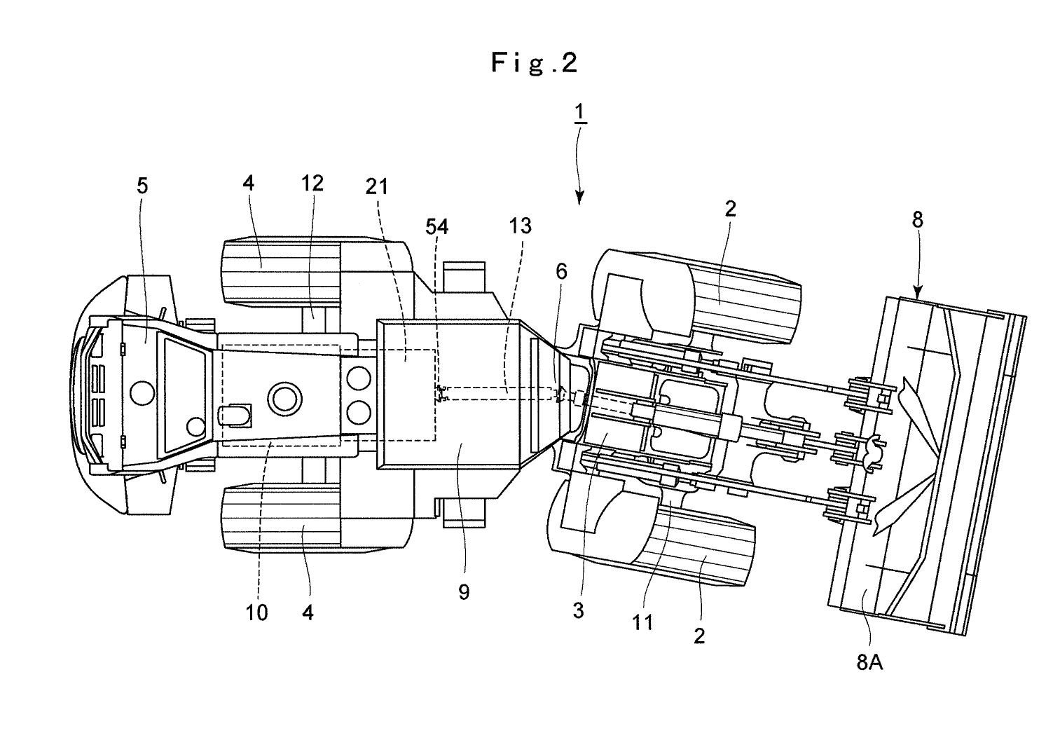

The connecting mechanism 6 includes upper and lower front brackets 6A protruding rearward from a rear end side of the front vehicle body 3, upper and lower rear brackets 6B protruding forward from the front end side of the rear vehicle body 5, and a connecting pin 6C which extends in the vertical direction and rotatably connects the front brackets 6A and the rear brackets 6B. A steering cylinder 7 is provided between the front vehicle body 3 and the rear vehicle body 5. The wheel loader 1 can perform steering during traveling by bending the front vehicle body 3 and the rear vehicle body 5 in the left and right directions around the connecting pin 6C of the connecting mechanism 6 through extension/contraction of this steering cylinder 7 (See FIG. 2).

Here, a working mechanism 8 provided with a loader bucket 8A is provided on the front vehicle body 3 of the wheel loader 1 capable of moving upward/downward. On the other hand, a cab 9 defining an operator's room, an engine 10 as a prime mover, a power transmission device 21 for a vehicle which will be described later and the like are provided on the rear vehicle body 5 of the wheel loader 1.

A front axle 11 (front wheel axis) extending in the left and right directions is provided on the lower side of the front vehicle body 3, and the left and right front wheels 2 are attached to the both end sides of the front axle 11. On the other hand, a rear axle 12 (rear wheel axis) extending in the left and right directions is provided on the lower side of the rear vehicle body 5, and the left and right rear wheels 4 are attached to the both end sides of the rear axle 12. The front axle 11 is connected to an output shaft 54 of the power transmission device 21 for a vehicle through a propeller shaft 13, and the rear axle 12 is connected to an output shaft 54 of the power transmission device 21 for a vehicle through a propeller shaft 14.

Next, the power transmission device for a vehicle used in this embodiment will be described.

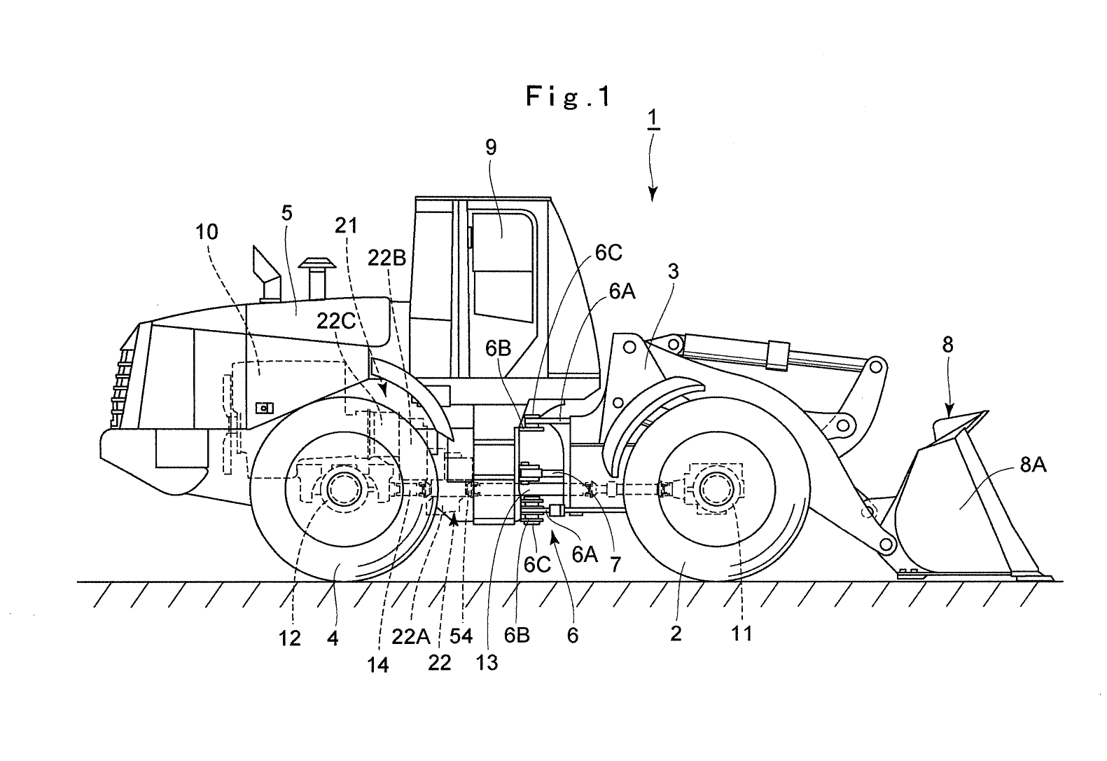

Designated at 21 is the power transmission device for a vehicle mounted on the wheel loader 1. As illustrated in FIGS. 1 and 2, the power transmission device 21 for a vehicle is connected to the engine 10 and reduces a speed of a rotation output of the engine 10 and transmits the result to the front axle 11 and the rear axle 12. Here, the power transmission device 21 for a vehicle includes a casing 22, a torque converter 23, a forward shaft 27, a backward shaft 34, a rotational shaft 35, first and second speed changing shafts 40 and 41, a first speed clutch mechanism 50, a second speed clutch mechanism 51, the output shaft 54, first and second brake devices 61 and 71 and the like, which will be described later.

Indicated at 22 is a casing forming an outer shell of the power transmission device 21 for a vehicle, and the torque converter 23, the forward shaft 27, the backward shaft 34, the rotational shaft 35, the first and second speed changing shafts 40 and 41, the first speed clutch mechanism 50, the second speed clutch mechanism 51, and the output shaft 54 are accommodated in the casing 22. The casing 22 is formed having a hollow box shape of a front casing 22A located on the front side in the front-rear direction, an intermediate casing 22B located in an intermediate portion, and a rear casing 22C located on the rear side. This casing 22 is arranged so that the rear casing 22C is opposed to the engine 10.

The torque converter 23 is arranged on the upper end side of the casing 22, and the torque converter 23 is connected to a crank shaft (not shown) of the engine 10 and transmits the rotation output of the engine 10 to a drive shaft 23A through oil. The drive shaft 23A of the torque converter 23 is supported by the rear casing 22C through a bearing 24 and also supported by the intermediate casing 22B through a bearing 25. A drive gear 26 is attached to one end side (front side) of the drive shaft 23A located in the intermediate casing 22B by being located in the vicinity of the bearing 25.

The forward shaft 27 is arranged on the lower side of the torque converter 23, and the forward shaft 27 is connected to the drive shaft 23A of the torque converter 23 through a forward clutch mechanism 33 which will be described later when the wheel loader 1 is made to travel forward. Here, one end side in the axial direction (front side) of the forward shaft 27 is supported by the intermediate casing 22B through a bearing 28 and the other end side in the axial direction (rear side) is supported by the rear casing 22C through a bearing 29.

An input gear 30 is provided at an intermediate portion in the axial direction of the forward shaft 27, and the input gear 30 is meshed with a drive gear 26 all the time. Here, a needle bearing 31 is provided between the input gear 30 and the forward shaft 27, and the input gear 30 is made rotatable with respect to the forward shaft 27. A forward clutch mechanism 33 which will be described later is provided between the forward shaft 27 and the input gear 30, and the forward shaft 27 and the input gear 30 can be switched between a connected state or open state (disconnected state) by the forward clutch mechanism 33. On the other hand, an output gear 32 is spline-connected to the other end side in the axial direction of the forward shaft 27, and the output gear 32 is integrally rotated with the forward shaft 27 all the time.

The hydraulic type forward clutch mechanism 33 is provided between the forward shaft 27 and the input gear 30, and the forward clutch mechanism 33 is operated when the wheel loader 1 is made to travel forward. That is, when the wheel loader 1 is made to travel forward, the forward clutch mechanism 33 is brought into the connected state so that the forward shaft 27 and the input gear 30 are brought into the connected state and integrated. As a result, rotation of the drive gear 26 is transmitted to the rotational shaft 35 which will be described later through the input gear 30, the forward shaft 27, and the output gear 32. On the other hand, if the wheel loader 1 is made to travel backward, the forward clutch mechanism 33 is brought into the open state so that the forward shaft 27 and the input gear 30 are disconnected from each other and power transmission to the forward shaft 27 is shut off.

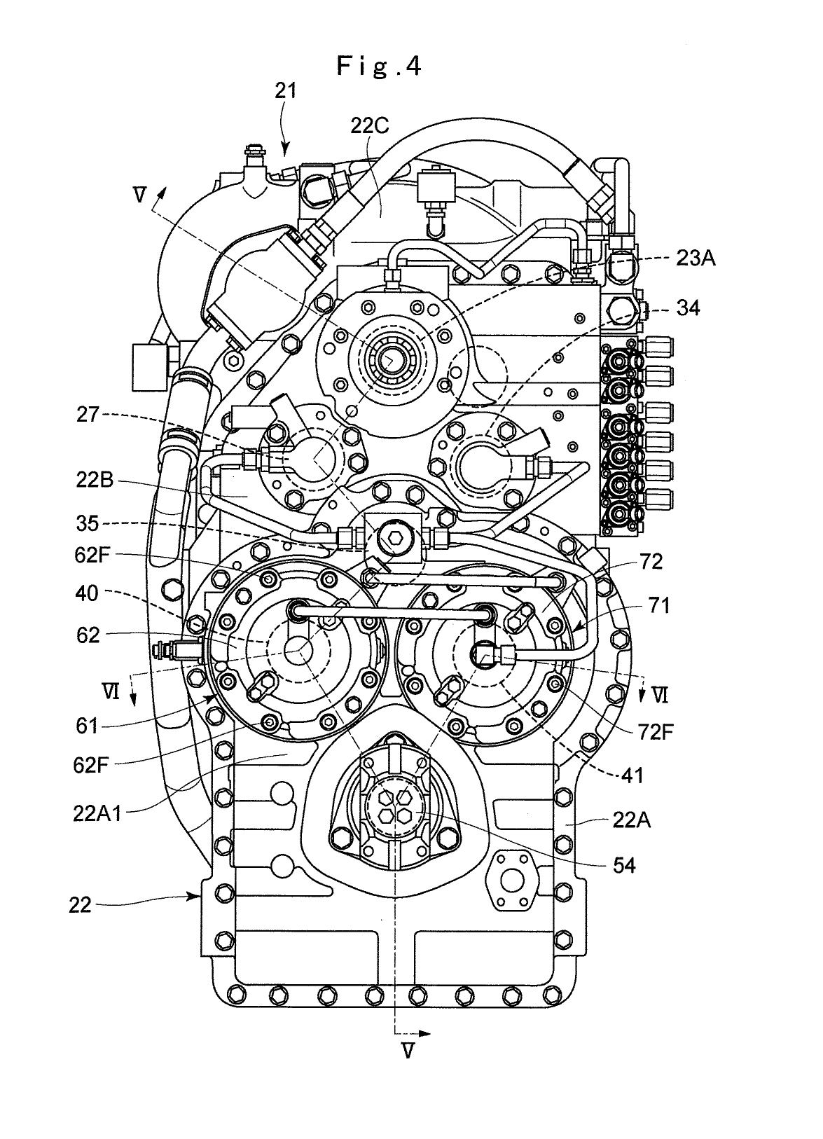

Here, as illustrated in FIG. 4, the backward shaft 34 is arranged on the side opposite to the forward shaft 27 sandwiching the drive shaft 23A of the torque converter 23. This backward shaft 34 is connected to the drive shaft 23A when the wheel loader 1 is made to travel backward. On this backward shaft 34, too, an input gear, an output gear, a backward clutch mechanism (none of them is shown) similar to those of the forward shaft 27 are provided. Therefore, by connecting the backward clutch mechanism while the forward clutch mechanism 33 is disconnected, the rotation of the drive gear 26 is transmitted to the rotational shaft 35 which will be described later through the backward shaft 34 and the like.

Indicated at 35 is the rotational shaft arranged on the lower side of the forward shaft 27 and the backward shaft 34. This rotational shaft 35 receives transmission of the rotation output of the engine 10 through the torque converter 23, the forward shaft 27, the backward shaft 34 and the like. Here, the one end side in the axial direction of the rotational shaft 35 is supported by the intermediate casing 22B through a bearing 36 and the other end side in the axial direction of the rotational shaft 35 is supported by the rear casing 22C through a bearing 37.

An output gear 38 is integrally formed on one end side in the axial direction of the rotational shaft 35 by being located in the vicinity of the bearing 36. This output gear 38 is meshed with a first speed input gear 44 of the first speed changing shaft 40 which will be described later all the time. An input/output gear 39 is spline-connected to the other end side in the axial direction of the rotational shaft 35 by being located in the vicinity of the bearing 37, and this input/output gear 39 is formed of a gear having a diameter larger than that of the output gear 38. The input/output gear 39 is meshed all the time with the output gear 32 provided on the forward shaft 27 and an output gear (not shown) provided on the backward shaft 34 and is meshed all the time with a second speed input gear 46 of the first speed changing shaft 40 which will be described later.

Subsequently, indicated at 40 is a first speed changing shaft arranged on the lower side of the rotational shaft 35, and indicated at 41 is a second speed changing shaft arranged also on the lower side of the rotational shaft 35. These speed changing shafts 40 and 41 are arranged side by side on the both left and right sides sandwiching the rotational shaft 35 and the output shaft 54 which will be described later. Here, the first speed changing shaft 40 converts the rotation of the rotational shaft 35 to either of a first speed rotation having the smallest rotation speed range or a second speed rotation having a rotation speed range larger than the first speed rotation and transmits the result to the output shaft 54 which will be described later. On the other hand, the second speed changing shaft 41 converts the rotation of the rotational shaft 35 to either of a third speed rotation having a rotation speed range larger than the above-described second speed rotation or a fourth speed rotation having a rotation speed range larger than the third speed rotation and transmits the result to the output shaft 54.

Here, since the first speed changing shaft 40 and the second speed changing shaft 41 are configured substantially similarly, the configuration of the first speed changing shaft 40 will be described below in detail, while the explanation of the configuration of the second speed changing shaft 41 will be omitted.

Regarding the first speed changing shaft 40, one end side in the axial direction is supported by the intermediate casing 22B through a bearing 42, while the other end side in the axial direction is supported by the rear casing 22C through a bearing 43. A one end portion (front end portion) in the axial direction of the first speed changing shaft 40 protrudes into the front casing 22A through the bearing 42.

The first speed input gear 44 is provided adjacently to the bearing 42 on one side in the axial direction of the first speed changing shaft 40 and the first speed input gear 44 is meshed all the time with the output gear 38 of the rotational shaft 35. A needle bearing 45 is provided between the first speed input gear 44 and the first speed changing shaft 40, and the first speed input gear 44 is made rotatable with respect to the first speed changing shaft 40. A first speed clutch mechanism 50 which will be described later is provided between the first speed changing shaft 40 and the first speed input gear 44, and a connected state and an open state (disconnected state) between the first speed changing shaft 40 and the first speed input gear 44 can be switched by the first speed clutch mechanism 50.

The second speed input gear 46 is provided adjacently to the bearing 43 and on the other side in the axial direction of the first speed changing shaft 40, the second speed input gear 46 is formed of a gear having a diameter smaller than the first speed input gear 44 and is meshed all the time with the input/output gear 39 attached to the rotational shaft 35. A needle bearing 47 is provided between the second speed input gear 46 and the first speed changing shaft 40, and the second speed input gear 46 is made rotatable with respect to the first speed changing shaft 40. A second speed clutch mechanism 51 which will be described later is provided between the first speed changing shaft 40 and the second speed input gear 46, and a connected state and an open state (disconnected state) between the first speed changing shaft 40 and the second speed input gear 46 can be switched by the second speed clutch mechanism 51.

An output gear 48 is spline-connected to one end portion (front end portion) in the axial direction of the first speed changing shaft 40, and the output gear 48 is arranged in the front casing 22A and meshed all the time with a low speed side input gear 57 of the output shaft 54 which will be described later. Here, on the output gear 48, a tubular portion 48A protruding to the side opposite to the first speed changing shaft 40 is provided. This tubular portion 48A is provided concentrically with the first speed changing shaft 40 and is supported by the front casing 22A through a bearing 49. One end side in the axial direction of the tubular portion 48A protrudes to the outside of the front casing 22A through the bearing 49 and extends into a first brake device 61 which will be described later.

Subsequently, indicted at 50 is a hydraulic first speed clutch mechanism provided between the first speed changing shaft 40 and the first speed input gear 44. This first speed clutch mechanism 50 is operated when the output shaft 54 which will be described later is rotated at the first speed. That is, when the first speed clutch mechanism 50 is connected, the first speed changing shaft 40 and the first speed input gear 44 enter the connected state and are integrated, while if the first speed clutch mechanism 50 is opened, the first speed changing shaft 40 and the first speed input gear 44 are disconnected (disconnected state).

Indicated at 51 is a hydraulic second speed clutch mechanism provided between the first speed changing shaft 40 and the second speed input gear 46. This second speed clutch mechanism 51 is operated when the output shaft 54 which will be described later is rotated at the second speed. That is, when the second speed clutch mechanism 51 is connected, the first speed changing shaft 40 and the second speed input gear 46 enter the connected state and are integrated, while if the second speed clutch mechanism 51 is opened, the first speed changing shaft 40 and the second speed input gear 46 are disconnected (disconnected state).

Therefore, if the wheel loader 1 is made to travel at first speed rotation, the first speed changing shaft 40 and the first speed input gear 44 are brought into the connected state by connecting the first speed clutch mechanism 50. As a result, the rotation of the rotational shaft 35 is transmitted to the output shaft 54 which will be described later through the output gear 38, the first speed input gear 44, the first speed changing shaft 40, and the output gear 48. On the other hand, if the wheel loader 1 is made to travel at second speed rotation, the first speed changing shaft 40 and the second speed input gear 46 are brought into the connected state by connecting the second speed clutch mechanism 51. As a result, the rotation of the rotational shaft 35 is transmitted to the output shaft 54 which will be described later through the input/output gear 39, the second speed input gear 46, the first speed changing shaft 40, and the output gear 48.

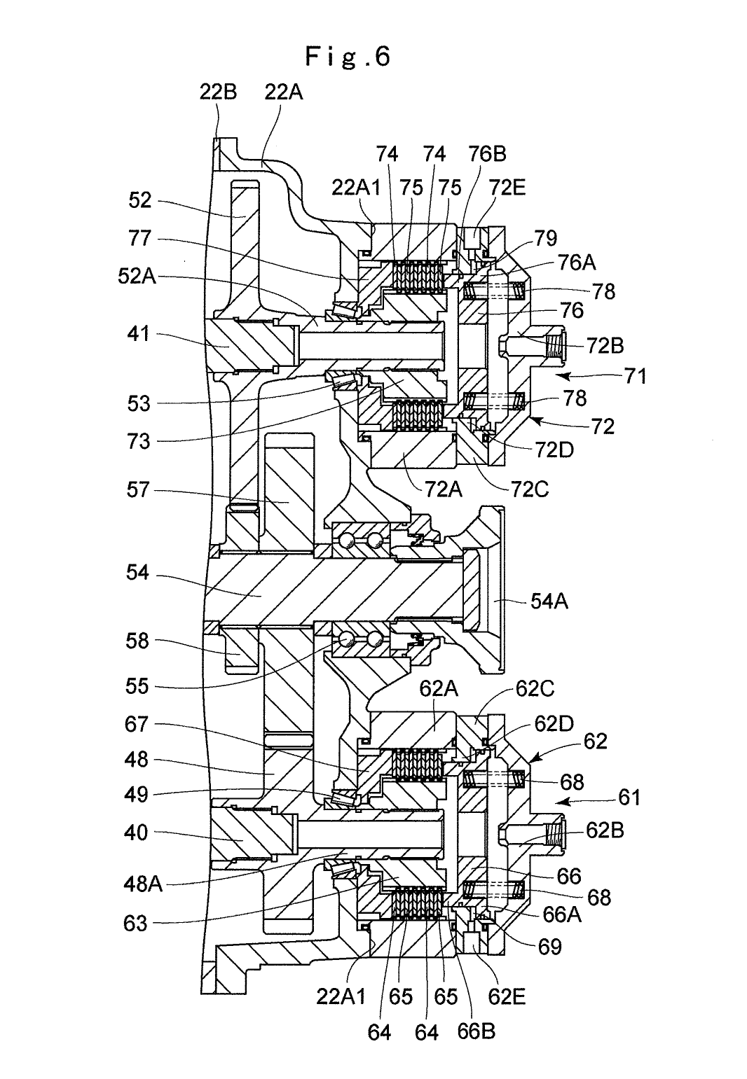

On the other hand, regarding the second speed changing shaft 41 arranged on the side opposite to the first speed changing shaft 40 sandwiching the output shaft 54, as illustrated in FIG. 6, one end side in the axial direction of the second speed changing shaft 41 protrudes into the front casing 22A. At one end portion of this second speed changing shaft 41, an output gear 52 is spline-connected. The output gear 52 is formed of a gear having a diameter larger than the output gear 48 attached to the first speed changing shaft 40 and is meshed all the time with a high speed side input gear 58 of the output shaft 54 which will be described later. Here, on the output gear 52, a tubular portion 52A protruding to the side opposite to the second speed changing shaft 41 is provided. This tubular portion 52A is provided concentrically with the second speed changing shaft 41 and is supported by the front casing 22A through a bearing 53. One end side in the axial direction of the tubular portion 52A protrudes to the outside of the front casing 22A through the bearing 53 and extends into a second brake device 71 which will be described later.

Therefore, if the wheel loader 1 is made to travel at third speed rotation, the second speed changing shaft 41 and a third speed input gear (not shown) are brought into the connected state by connecting a third speed clutch mechanism (not shown). As a result, the rotation of the rotational shaft 35 is transmitted to the output shaft 54 which will be described later through the output gear 38, a third speed input gear (not shown), the second speed changing shaft 41, and the output gear 52. On the other hand, if the wheel loader 1 is made to travel at fourth speed rotation, the second speed changing shaft 41 and a fourth speed input gear (not shown) are brought into the connected state by connecting a fourth speed clutch mechanism (not shown). As a result, the rotation of the rotational shaft 35 is transmitted to the output shaft 54 which will be described later through the input/output gear 39, a fourth speed input gear (not shown), the second speed changing shaft 41, and the output gear 52.

Indicated at 54 is an output shaft arranged on the lower side of the first speed changing shaft 40 and the second speed changing shaft 41. This output shaft 54 outputs either one of the rotation of the first speed changing shaft 40 (first speed rotation or second speed rotation) selected by the first speed clutch mechanism 50 or the second speed clutch mechanism 51 and the rotation of the second speed changing shaft 41 (third speed rotation or fourth speed rotation) selected by the third speed clutch mechanism or the fourth speed clutch mechanism (neither of them is shown). Here, one end side in the axial direction of the output shaft 54 is supported by the front casing 22A through a bearing 55, while the other end side in the axial direction of the output shaft 54 is supported by the intermediate casing 22B through a bearing 56.

Moreover, the one end side of the output shaft 54 protrudes to the outside of the front casing 22A through the bearing 55, and a front flange 54A is attached to a protrusion end portion of the output shaft 54. The propeller shaft 13 is connected to the front flange 54A of the output shaft 54, and the rotation output of the output shaft 54 is transmitted to the front axle 11 of the wheel loader 1 through the propeller shaft 13.

On the other hand, the other end side of the output shaft 54 protrudes to the outside of the intermediate casing 22B through the bearing 56, and a rear flange 54B is attached to a protrusion end portion of the output shaft 54. The propeller shaft 14 is connected to the rear flange 54B of the output shaft 54, and the rotation output of the output shaft 54 is transmitted to the rear axle 12 of the wheel loader 1 through the propeller shaft 14.

The low speed side input gear 57 is spline-connected to an intermediate portion in the axial direction of the output shaft 54, and the low speed side input gear 57 is located in the vicinity of the bearing 55 and arranged in the front casing 22A and is meshed all the time with the output gear 48 attached to the first speed changing shaft 40. Therefore, if the rotation of the rotational shaft 35 is transmitted to the first speed changing shaft 40 through the first speed clutch mechanism 50 or the second speed clutch mechanism 51, the rotation of this first speed changing shaft 40 (first speed rotation or second speed rotation) is transmitted to the output shaft 54 through the output gear 48 and the low speed side input gear 57. The rotation of this output shaft 54 is transmitted to the front axle 11 of the wheel loader 1 through the front side propeller shaft 13 and also transmitted to the rear axle 12 through the rear side propeller shaft 14.

The high speed side input gear 58 is adjacent to the low speed side input gear 57 and is spline-connected to the intermediate portion in the axial direction of the output shaft 54. As illustrated in FIG. 6, the high speed side input gear 58 is formed of a gear having a diameter smaller than the low speed side input gear 57 and is meshed all the time with the output gear 52 attached to the second speed changing shaft 41. Therefore, if the rotation of the rotational shaft 35 is transmitted to the second speed changing shaft 41 through the third speed clutch mechanism or the fourth speed clutch mechanism (neither of them is shown), the rotation of this second speed changing shaft 41 (third speed rotation or fourth speed rotation) is transmitted to the output shaft 54 through the output gear 52 and the high speed side input gear 58. The rotation of this output shaft 54 is transmitted to the front axle 11 of the wheel loader 1 through the front side propeller shaft 13 and also transmitted to the rear axle 12 through the rear side propeller shaft 14.

As described above, the output shaft 54 is connected to the first speed changing shaft 40 all the time through the low speed side input gear 57 and the output gear 48 and is connected to the second speed changing shaft 41 all the time through the high speed side input gear 58 and the output gear 52. Thus, if the output shaft 54 rotates and the wheel loader 1 travels, the first speed changing shaft 40 and the second speed changing shaft 41 rotate integrally with the output shaft 54 all the time.

Next, the first and second brake devices used in the power transmission device 21 for a vehicle according to this embodiment will be described.

Designated at 61 is the first brake device provided on the casing 22, and the first brake device 61 applies a braking force to the first speed changing shaft 40. This first brake device 61 is arranged closer to one end side (front end side) in the axial direction of the first speed changing shaft 40 and is detachably attached to a front surface 22A1 opposing the connecting mechanism 6 illustrated in FIG. 1 in the front casing 22A constituting the casing 22. The first brake device 61 is formed of a wet multidisk negative brake, for example, and when the wheel loader 1 is parked or if the traveling wheel loader 1 is brought to emergency stop, the first brake device 61 applies a braking force to the first speed changing shaft 40. On the other hand, the first brake device 61 releases the braking force to the first speed changing shaft 40 while the wheel loader 1 is traveling. Here, as illustrated in FIG. 6, the first brake device 61 includes a brake case 62, an adapter 63, each of fixed-side brake disks 64, each of rotating-side brake disks 65, a brake piston 66, a spring member 68, and an oil chamber 69, which will be described later.

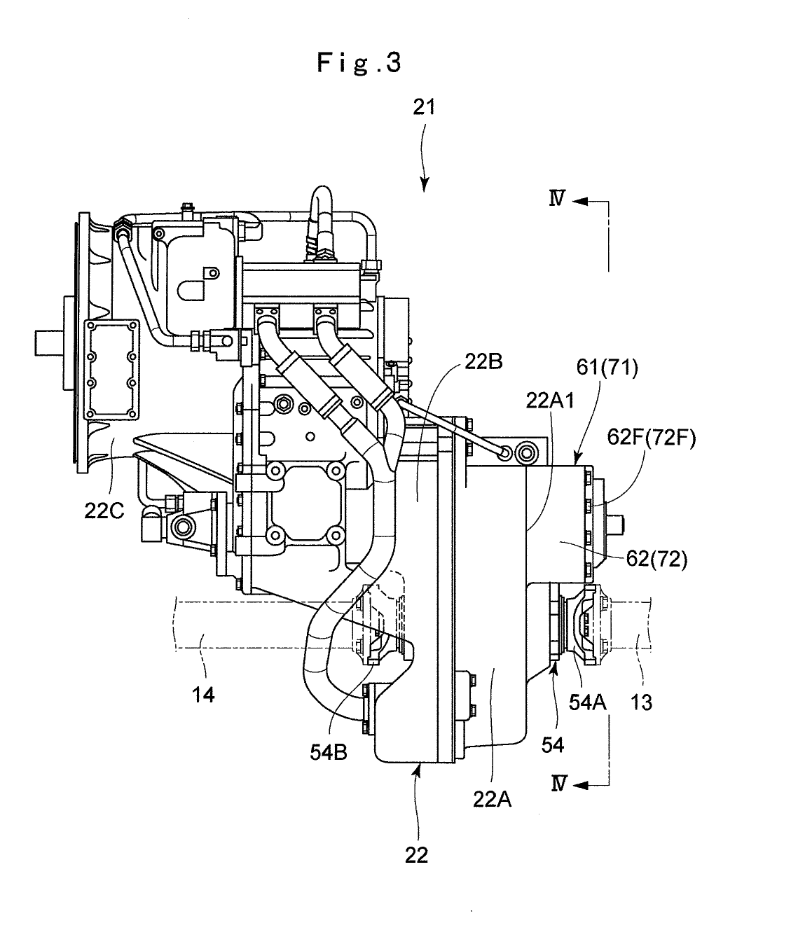

The brake case 62 forms an outer shell of the first brake device 61, and the brake case 62 is detachably attached to the front surface 22A1 of the front casing 22A. Here, the brake case 62 includes a tubular main body portion 62A surrounding the tubular portion 48A of the output gear 48 from the outer peripheral side, a lid portion 62B which lids an opening side of the main body portion 62A, and an intermediate tubular portion 62C sandwiched between the main body portion 62A and the lid portion 62B. In the intermediate tubular portion 62C, an inward projecting portion 62D annularly extending inward in the radial direction is provided and also, a brake release pressure inlet port 62E is provided. On the other hand, each of the fixed-side brake disks 64 and each of the rotating-side brake disks 65 are accommodated in an inner peripheral side of the main body portion 62A, and the brake piston 66 is slidably inserted and fitted in the inner peripheral side of the intermediate tubular portion 62C. As illustrated in FIGS. 3 and 4, the brake case 62 is attached to the front surface 22A1 of the front casing 22A by a plurality of bolts 62F.

The cylindrical adapter 63 is attached to an outer peripheral side of the tubular portion 48A of the output gear 48. This adapter 63 is spline-connected to the outer peripheral side of the tubular portion 48A at the inner peripheral side thereof and rotates integrally with the first speed changing shaft 40. Each of the rotating-side brake disks 65 which will be described later is spline-connected to the outer peripheral side of the adapter 63.

The plurality of fixed-side brake disks 64 are arranged on the inner peripheral side of the brake case 62, and each of the fixed-side brake disks 64 is formed as an annular plate body by using a metal material, for example. Each of the fixed-side brake disks 64 is spline-connected to an inner peripheral surface of the main body portion 62A forming the brake case 62 in a state alternately overlapping with the rotating-side brake disks 65 which will be described later in the axial direction. Therefore, each of the fixed-side brake disks 64 is movable in the axial direction with respect to the brake case 62 and is unrotatable in the peripheral direction with respect to the brake case 62.

The plurality of rotating-side brake disks 65 are arranged with each of the fixed-side brake disks 64 on the inner peripheral side of the brake case 62, and the rotating-side brake disk 65 is formed as an annular plate body by using a metal material, for example. Each of the rotating-side brake disks 65 is spline-connected to an outer peripheral surface of the adapter 63 in a state alternately overlapping with the fixed-side brake disks 64 in the axial direction. Therefore, each of the rotating-side brake disks 65 is movable in the axial direction with respect to the adapter 63 and is unrotatable in the peripheral direction with respect to the adapter 63.

The brake piston 66 is inserted and fitted in the inner peripheral side of the intermediate tubular portion 62C forming the brake case 62, and the brake piston 66 applies a braking force to the first speed changing shaft 40 through the adapter 63 and the output gear 48 by pressing and frictionally engaging each of the fixed-side brake disks 64 and each of the rotating-side brake disks 65 with each other. Here, the brake piston 66 is formed having a stepped cylindrical shape including a large diameter portion 66A in sliding contact with the inner peripheral surface of the intermediate tubular portion 62C and a small diameter portion 66B in sliding contact with the inner peripheral surface of the inward projecting portion 62D provided on the intermediate tubular portion 62C.

A back-up ring 67 is formed as a hollow disk-shaped body, and the back-up ring 67 is located between the front surface 22A1 of the front casing 22A and the brake piston 66 and is provided in the brake case 62. This back-up ring 67 regulates axial movement of the fixed-side brake disk 64 and the rotating-side brake disk 65 pressed by the spring member 68 which will be described later.

A plurality of the spring members 68 are provided between the brake case 62 and the brake piston 66, and each of the spring members 68 is formed of a compression coil spring and is contracted and attached between the lid portion 62B of the brake case 62 and the large diameter portion 66A of the brake piston 66. Each of the spring members 68 biases the brake piston 66 in a direction of pressing the fixed-side brake disk 64 and the rotating-side brake disk 65 all the time. As a result, each of the brake disks 64 and 65 is sandwiched between the brake piston 66 and the back-up ring 67 and applies the braking force to the first speed changing shaft 40.

The oil chamber 69 for brake release is provided between the intermediate tubular portion 62C of the brake case 62 and the brake piston 66, and the oil chamber 69 is formed annularly over the entire periphery between the inward projecting portion 62D of the intermediate tubular portion 62C and the large diameter portion 66A of the brake piston 66. This oil chamber 69 communicates with the brake release pressure inlet port 62E provided in the intermediate tubular portion 62C.

Therefore, if pressurized oil (brake release pressure) from a hydraulic pump 81 which will be described later is not supplied into the oil chamber 69 through the brake release pressure inlet port 62E, the brake piston 66 frictionally engages each of the fixed-side brake disks 64 and each of the rotating-side brake disks 65 by a biasing force of the spring member 68. As a result, the first brake device 61 applies the braking force to the first speed changing shaft 40. On the other hand, if the pressurized oil from the hydraulic pump 81 is supplied into the oil chamber 69 through the brake release pressure inlet port 62E, the brake piston 66 separates from the rotating-side brake disk 65 against the biasing force of the spring member 68. As a result, the first brake device 61 releases the braking force to the first speed changing shaft 40.

Subsequently, designated at 71 is the second brake device provided between the casing 22 and the second speed changing shaft 41, and the second brake device 71 applies a braking force to the second speed changing shaft 41. This second brake device 71 is arranged closer to one end side (front end side) in the axial direction of the second speed changing shaft 41 and is detachably attached to the front surface 22A1 of the front casing 22A forming the casing 22. The second brake device 71 is formed of a wet multidisk negative brake, for example, and when the wheel loader 1 is parked or the traveling wheel loader 1 is brought to emergency stop, the second brake device 71 applies the braking force to the second speed changing shaft 41. On the other hand, the second brake device 71 releases the braking force to the second speed changing shaft 41 while the wheel loader 1 is traveling.

A brake case 72 of the second brake device 71 is detachably attached to the front surface 22A1 of the front casing 22A in a state surrounding the tubular portion 52A of the output gear 52 from the outer peripheral side. Here, the brake case 72 is formed of a main body portion 72A, a lid portion 72B, an intermediate tubular portion 72C, an inward projecting portion 72D, and a brake release pressure inlet port 72E similarly to the brake case 62 of the first brake device 61. As illustrated in FIGS. 3 and 4, the brake case 72 is attached to the front surface 22A1 of the front casing 22A by a plurality of bolts 72F.

On the other hand, in the brake case 72, the adapter 73 spline-connected to the outer peripheral side of the tubular portion 52A of the output gear 52, the plurality of fixed-side brake disks 74 spline-connected to the inner peripheral side of the main body portion 72A, and the plurality of rotating-side brake disks 75 spline-connected to the outer peripheral side of the adapter 73 in a state alternately overlapping with each of the fixed-side brake disks 74 are provided. Moreover, in the brake case 72, a brake piston 76 having a large diameter portion 76A and a small diameter portion 76B and slidably inserted and fitted on the inner peripheral side of the intermediate tubular portion 72C and a back-up ring 77 which regulates movement in the axial direction of each of the fixed-side brake disks 74 and each of the rotating-side brake disks 75 are provided. Furthermore, in the brake case 72, a spring member 78 which biases the brake piston 76 in a direction of pressing the fixed-side brake disk 74 and the rotating-side brake disk 75 all the time and an oil chamber 79 provided between the intermediate tubular portion 72C and the brake piston 76 and into which pressurized oil for brake release is introduced are provided.

Therefore, when the pressurized oil (brake release pressure) from the hydraulic pump 81 which will be described later is not supplied into the oil chamber 79 through the brake release pressure inlet port 72E, the brake piston 76 of the second brake device 71 frictionally engages each of the fixed-side brake disks 74 and each of the rotating-side brake disks 75 by a biasing force of the spring member 78. As a result, the second brake device 71 applies the braking force to the second speed changing shaft 41. On the other hand, when the pressurized oil from the hydraulic pump 81 is supplied into the oil chamber 79 through the brake release pressure inlet port 72E, the brake piston 76 separates from the rotating-side brake disk 75 against the biasing force of the spring member 78. As a result, the second brake device 71 releases the braking force to the second speed changing shaft 41.

In this case, the output shaft 54 is connected to the first speed changing shaft 40 and the second speed changing shaft 41 all the time. Thus, the braking force can be applied by the first brake device 61 to the first speed changing shaft 40, and the braking force can be applied by the second brake device 71 to the second speed changing shaft 41 at the same time. As a result, a large braking force combined by the first and second brake devices 61 and 71 can be applied to the output shaft 54. Therefore, if the traveling wheel loader 1 is brought to emergency stop, the wheel loader 1 can be stopped rapidly and reliably by the large braking force by the first and second brake devices 61 and 71.

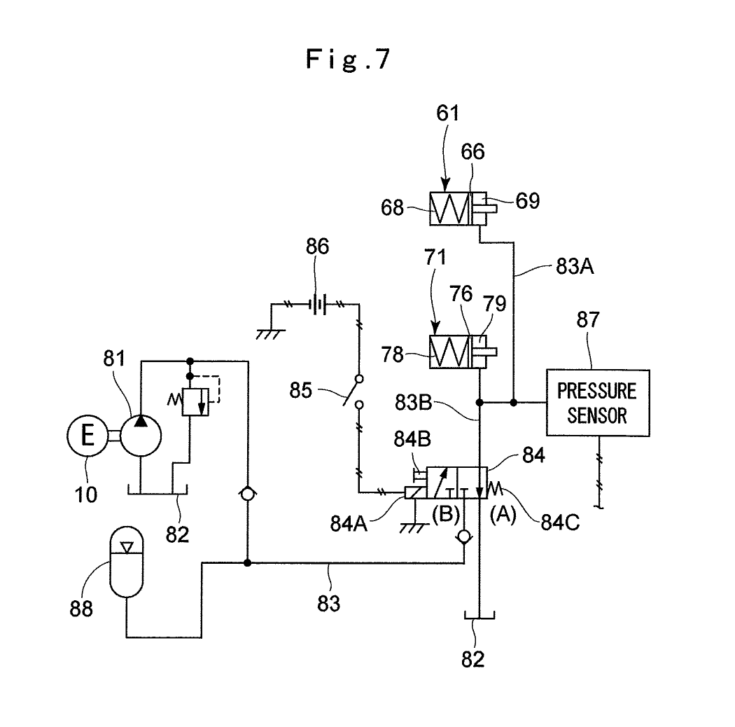

Next, a hydraulic circuit for supplying the pressurized oil (brake release pressure) to the oil chamber 69 of the first brake device 61 and the oil chamber 79 of the second brake device 71 will be described by referring to FIG. 7.

The hydraulic pump 81 is rotated and driven by the engine 10 so as to discharge operating oil stored in an operating oil tank 82 as the pressurized oil into an oil passage 83. On the other hand, the oil passage 83 is connected to the oil chamber 69 of the first brake device 61 through a first branch oil passage 83A and also connected to the oil chamber 79 of the second brake device 71 through a second branch oil passage 83B. The hydraulic pump 81 and the operating oil tank 82 constitute a hydraulic source.

A brake control valve 84 is located between each of the oil chambers 69 and 79 and the hydraulic pump 81 and provided in the middle of the oil passage 83, and the brake control valve 84 is made of a 3-port and 2-position electromagnetic valve, for example, that can be manually operated. An electromagnetic pilot portion 84A and a manual control lever 84B are provided on the brake control valve 84 and also, a return spring 84C is provided, and the electromagnetic pilot portion 84A is connected to a power supply 86 through a brake release switch 85.

The brake release switch 85 is opened when the wheel loader 1 is parked or when the traveling wheel loader 1 is brought to emergency stop and closed when the wheel loader 1 is to be made to travel. The brake control valve 84 maintains a brake position (A) by the return spring 84C when a signal (an electric current from the power supply 86) is not supplied to the electromagnetic pilot portion 84A through opening of the brake release switch 85. On the other hand, the brake control valve 84 is switched to a brake release position (B) when a signal is supplied to the electromagnetic pilot portion 84A through closing of the brake release switch 85.

Therefore, if the brake release switch 85 is opened when the wheel loader 1 is parked or in order to bring the traveling wheel loader 1 to emergency stop, the brake control valve 84 maintains the brake position (A). At this time, the supply of the pressurized oil to the oil chamber 69 of the first brake device 61 and the oil chamber 79 of the second brake device 71 is stopped. Therefore, the brake piston 66 of the first brake device 61 frictionally engages each of the fixed-side brake disks 64 and each of the rotating-side brake disks 65 with each other by the biasing force of the spring member 68, the braking force is applied to the first speed changing shaft 40. On the other hand, at the same time, the brake piston 76 of the second brake device 71 frictionally engages each of the fixed-side brake disks 74 and each of the rotating-side brake disks 75 with each other by the biasing force of the spring member 78, whereby the braking force is applied to the second speed changing shaft 41.

On the other hand, if the brake release switch 85 is closed in order to make the wheel loader 1 travel, the brake control valve 84 is switched to the brake release position (B). At this time, the pressurized oil (brake release pressure) is supplied from the hydraulic pump 81 to the oil chamber 69 of the first brake device 61 and the oil chamber 79 of the second brake device 71. Therefore, the brake piston 66 of the first brake device 61 separates away from the rotating-side brake disk 65 against the biasing force of the spring member 68, whereby the braking force to the first speed changing shaft 40 is released. On the other hand, at the same time, the brake piston 76 of the second brake device 71 separates away from the rotating-side brake disk 75 against the biasing force of the spring member 78, whereby the braking force to the second speed changing shaft 41 is released.

A pressure sensor 87 is provided in the middle of the oil passage 83 by being located between each of the oil chambers 69 and 79 and the brake control valve 84. This pressure sensor 87 detects a pressure of a brake release pressure supplied to the oil chambers 69 and 79 of the first and second brake devices 61 and 71. If the brake release pressure becomes a pressure lower than a predetermined value, the pressure sensor 87 lights an alarm lamp (not shown) in the cab 9, for example, so as to notify it to the driver. An accumulator 88 is connected to the middle of the oil passage 83 by being located between the hydraulic pump 81 and the brake control valve 84. This accumulator 88 supplies the brake release pressure to each of the oil chambers 69 and 79 in place of this hydraulic pump 81 if a discharge pressure from the hydraulic pump 81 lowers due to some reason.

The power transmission device 21 for a vehicle according to this embodiment has the configuration as above and an operation of this power transmission device 21 for a vehicle will be described below.

When the wheel loader 1 is parked, the brake release switch 85 in FIG. 7 is opened, and the brake control valve 84 maintains the brake position (A). Therefore, the brake release pressure from the hydraulic pump 81 is not supplied to the oil chamber 69 of the first brake device 61 and the oil chamber 79 of the second brake device 71. In this state, the first brake device 61 applies the braking force to the first speed changing shaft 40, and the second brake device 71 applies the braking force to the second speed changing shaft 41.

As a result, the large braking force combining the braking forces of the first and second brake devices 61 and 71 is applied to the output shaft 54 to which the first and second speed changing shafts 40 and 41 are connected, and the wheel loader 1 can maintain a stable parking attitude even on a slope and the like.

Subsequently, when the wheel loader 1 is to be made to travel, the driver operates the engine 10 and opens the brake release switch 85. As a result, the brake control valve 84 is switched to the brake release position (B), and the pressurized oil (brake release pressure) from the hydraulic pump 81 is supplied to the oil chamber 69 of the first brake device 61 and the oil chamber 79 of the second brake device 71 through the oil passage 83 simultaneously. As a result, the braking force from the first brake device 61 to the first speed changing shaft 40 and the braking force from the second brake device 71 to the second speed changing shaft 41 are simultaneously released.

On the other hand, the rotation output of the engine 10 is transmitted to the rotational shaft 35 through the torque converter 23, the forward shaft 27 and the like of the power transmission device 21 for a vehicle. Here, if the wheel loader 1 is to be made to travel at the first speed rotation, the first speed clutch mechanism 50 is connected so that the first speed changing shaft 40 and the first speed input gear 44 are brought into the connected state. As a result, the rotation of the rotational shaft 35 is transmitted to the first speed changing shaft 40 through the output gear 38 and the first speed input gear 44.

Therefore, the rotation of the first speed changing shaft 40 is transmitted from the output gear 48 to the low speed side input gear 57 of the output shaft 54, and the output shaft 54 is rotated at the first speed rotation. At this time, the high speed side input gear 58 attached together with the low speed side input gear 57 to the output shaft 54 is meshed with the output gear 52 of the second speed changing shaft 41 all the time, and thus, the second speed changing shaft 41 is integrally rotated with the output shaft 54.

The rotation of the output shaft 54 is transmitted to the front axle 11 through the propeller shaft 13 and also transmitted to the rear axle 12 through the propeller shaft 14. As a result, the left and right front wheels 2 attached to the front axle 11 and the left and right rear wheels 4 attached to the rear axle 12 are rotated, and the wheel loader 1 can be made to travel at the first speed rotation.

Subsequently, if the traveling wheel loader 1 is brought to emergency stop, the driver opens the brake release switch 85 and switches the brake control valve 84 to the brake position (A). As a result, the supply of the pressurized oil to the oil chamber 69 of the first brake device 61 and the oil chamber 79 of the second brake device 71 is shut off. In this state, the first brake device 61 applies the braking force to the first speed changing shaft 40 and the second brake device 71 applies the braking force to the second speed changing shaft 41.

As described above, the braking force can be applied simultaneously to the first speed changing shaft 40 connected to the output shaft 54 through the output gear 48 and the low speed side input gear 57 and the second speed changing shaft 41 connected to the output shaft 54 through the output gear 52 and the high speed side input gear 58. Therefore, the output shaft 54 can receive a large braking force combining the braking force of the first brake device 61 and the braking force of the second brake device 71. As a result, the traveling wheel loader 1 can be stopped rapidly and reliably.

Then, according to this embodiment, it is so configured that the first brake device 61 is provided on the casing 22, and the braking force is applied to the first speed changing shaft 40 connected to the output shaft 54 all the time through the output gear 48 and the low speed side input gear 57, while the second brake device 71 is provided on the casing 22, and the braking force is applied to the second speed changing shaft 41 connected to the output shaft 54 all the time through the output gear 52 and the high speed side input gear 58.

As a result, if the rotational shaft 35 and the first speed changing shaft 40 are connected to each other by the first speed clutch mechanism 50 or the second speed clutch mechanism 51, for example, the braking force can be applied by the first brake device 61 to the first speed changing shaft 40 connected to this rotational shaft 35. At the same time, the braking force can be also applied to the second speed changing shaft 41 not connected to the rotational shaft 35 by using the second brake device 71.

As a result, if the traveling wheel loader 1 is brought to emergency stop, for example, a large braking force combining the braking forces of the first and second brake devices 61 and 71 can be applied to the output shaft 54. Thus, as compared with provision of a single brake device between any one of the plurality of speed changing shafts and the casing, the traveling wheel loader 1 can be stopped quickly and reliably.

Moreover, by providing the first brake device 61 on the first speed changing shaft 40 and the second brake device 71 on the second speed changing shaft 41, the braking force to be applied to the output shaft 54 can be increased. As a result, there is no need to increase the numbers of the fixed-side brake disks 64 and the rotating-side brake disks 65 of the first brake device 61, and a sufficient gap can be ensured between each of the fixed-side brake disks 64 and each of the rotating-side brake disks 65. Similarly, there is no need to increase the numbers of the fixed-side brake disks 74 and the rotating-side brake disks 75 of the second brake device 71, and a sufficient gap can be ensured between each of the fixed-side brake disks 74 and each of the rotating-side brake disks 75.

As a result, during traveling of the wheel loader 1, contact between the fixed-side brake disk 64 and the rotating-side brake disk 65 can be avoided, and contact between the fixed-side brake disk 74 and the rotating-side brake disk 75 can be avoided. Therefore, heat generation from the first and second brake devices 61 and 71 can be suppressed, and moreover, each of the rotating-side brake disks 65 of the first brake device 61 and each of the rotating-side brake disks 75 of the second brake device 71 can be smoothly rotated. As a result, energy loss transmitted to the output shaft 54 can be suppressed, and the rotation output of the engine 10 can be efficiently transmitted to the front wheels 2 and the rear wheels 4 through the power transmission device 21 for a vehicle.

Moreover, by suppressing the number of rotating-side brake disks 65 attached to the first speed changing shaft 40 and by suppressing the number of the rotating-side brake disks 75 attached to the second speed changing shaft 41, the axial dimension of the first speed changing shaft 40 and the axial dimension of the second speed changing shaft 41 can be reduced. As a result, as compared with attachment of a large number of rotating-side brake disks to one speed changing shaft, the entire power transmission device 21 for a vehicle can be configured in a compact manner.

On the other hand, the first brake device 61 is arranged closer to one end side in the axial direction of the first speed changing shaft 40, and the second brake device 71 is arranged closer to one end side in the axial direction of the second speed changing shaft 41. As a result, the first and second brake devices 61 and 71 can be collectively arranged on the same side (front end side) in the axial direction of the first and second speed changing shafts 40 and 41. Therefore, a hydraulic hose (not shown) for supplying the pressurized oil from the hydraulic pump 81 to the oil chamber 69 of the first brake device 61 and a hydraulic hose (not shown) for supplying the pressurized oil from the hydraulic pump 81 to the oil chamber 79 of the second brake device 71 can be set substantially to the same length. As a result, supply/discharge of the pressurized oil to the first and second brake devices 61 and 71 can be performed at the same time, and operating timing of the first and second brake devices 61 and 71 can be coincided with each other.

Moreover, the casing 22 constituting the power transmission device 21 for a vehicle is mounted on the rear vehicle body 5 of the wheel loader 1, and the first brake device 61 and the second brake device 71 are detachably attached to the front surface 22A1 of the front casing 22A opposing the connecting mechanism 6. Thus, a large quantity of cooling air can be supplied to the first and second brake devices 61 and 71 by using traveling wind pressure when the wheel loader 1 is traveling. As a result, the power transmission device 21 for a vehicle including these first and second brake devices 61 and 71 can be efficiently cooled.

Furthermore, as illustrated in FIG. 2, the front vehicle body 3 and the rear vehicle body 5 of the wheel loader 1 are bent around the connecting mechanism 6 so that the first and second brake devices 61 and 71 can be easily attached to and removed from the front surface 22A1 of the front casing 22A opposing the connecting mechanism 6. As a result, workability when a maintenance work is performed for the first and second brake devices 61 and 71 can be improved.

It should be noted that, in the above-described embodiment, the example in which two speed changing shafts, that is, the first speed changing shaft 40 and the second speed changing shaft 41 are provided on the power transmission device 21 for a vehicle, and two brake devices, that is, the first brake device 61 and the second brake device 71 are provided between these first and second speed changing shafts 40 and 41 and the casing 22 is illustrated. However, the present invention is not limited to the same, and it is possible to adapt a configuration in which three or more speed changing shafts are provided, and three or more brake devices corresponding to the number of these speed changing shafts are provided.

In the above-described embodiment, the example in which the power transmission device 21 for a vehicle is mounted on the rear vehicle body 5 of the wheel loader 1, and the first and second brake devices 61 and 71 are arranged oppositely to the connecting mechanism 6 is illustrated. However, the present invention is not limited to the same, and it is possible to adapt a configuration in which the power transmission device 21 for a vehicle is mounted on the front vehicle body 3, for example, and the first and second brake devices 61 and 71 are arranged opposite to the connecting mechanism 6.

Furthermore, in the above-described embodiment, the wheel loader 1 is exemplified as a working vehicle on which the power transmission device 21 for a vehicle is mounted. However, the present invention is not limited to the same, but can be widely applied to other working vehicles including a construction vehicle such as a wheel excavator, a transport vehicle such as a lift truck, and an agricultural vehicle such as a tractor, for example.

### DESCRIPTION OF REFERENCE NUMERALS

1: Wheel loader (Vehicle)
2: Front wheel
3: Front vehicle body (Vehicle body)
4: Rear wheel
5: Rear vehicle body (Vehicle body)
6: Connecting mechanism
10: Engine (Prime mover)
21: Power transmission device for a vehicle
22: Casing
35: Rotational shaft
40: First speed changing shaft (Speed changing shaft)
41: Second speed changing shaft (Speed changing shaft)
48: Output gear (Gear)
50: First speed clutch mechanism (Clutch mechanism)
51: Second speed clutch mechanism (Clutch mechanism)
52: Output gear (Gear)
54: Output shaft
57: Low speed side input gear (Gear)
58: High speed side input gear (Gear)
61: First brake device
Second brake device

1. A power transmission device for a vehicle comprising:
a casing mounted on a vehicle;
a rotational shaft rotatably supported in said casing and rotated by a prime mover mounted on said vehicle;
a plurality of speed changing shafts juxtaposed in parallel in said casing and rotatably supported, each changing rotation of said rotational shaft to different rotation numbers;
a clutch mechanism provided between said rotational shaft and each of said speed changing shafts and selectively connecting any one of said speed changing shafts and said rotational shaft; and
an output shaft connected to each of said speed changing shafts all the time through a gear and outputting the rotation of the one of the speed changing shafts selected by said clutch mechanism to a wheel of said vehicle, wherein
a plurality of brake devices, each applying a braking force to each of said speed changing shafts, are provided in said casing.

2. The power transmission device for a vehicle according to claim 1, wherein said plurality of brake devices are arranged closer to one side in the axial direction with respect to said plurality of speed changing shafts.

3. The power transmission device for a vehicle according to claim 1, wherein either one of said speed changing shafts and the other speed changing shaft are arranged on the both sides sandwiching said output shaft, respectively, in said casing.

4. The power transmission device for a vehicle according to claim 1, wherein said casing is formed of a front casing, an intermediate casing located on the rear side of said front casing, and a rear casing located on the rear side of said intermediate casing;
said rotational shaft is supported by said intermediate casing and said rear casing;
each of said speed changing shafts is located on the lower side of said rotational shaft and supported by said intermediate casing and said rear casing, respectively, so as to oppose each other in the left and right directions;
said output shaft is located on the lower side of each of said speed changing shafts and supported by said intermediate casing and said front casing; and
each of said brake devices is located on the front end side of each of said speed changing shafts and provided on a front surface of said front casing.

5. The power transmission device for a vehicle according to claim 1, wherein each of said brake devices is configured as a negative-type brake which releases braking by supply of pressurized oil to an oil chamber;
a hydraulic pump and each of said brake devices are connected to each other through an oil passage, and a brake control valve having a brake release position where the pressurized oil is supplied from a hydraulic pump to said oil chamber of each of said brake devices so as to release the braking force and a brake position where said oil chamber of each of said brake devices is connected to a tank so as to apply the braking force is provided in the middle of said oil passage; and
each of said brake devices applies the braking force by said brake control valve to each of said speed changing shafts simultaneously or releases the braking force of each of said speed changing shafts simultaneously.

6. The power transmission device for a vehicle according to claim 1, wherein said vehicle includes a front vehicle body on which front wheels are provided, a rear vehicle body on which rear wheels are provided and a connecting mechanism which is provided between said front vehicle body and said rear vehicle body and connects said front vehicle body and said rear vehicle body bendably in the left and right directions; and
said prime mover is mounted on either one of said front vehicle body and said rear vehicle body, said casing is located between said connecting mechanism and said prime mover on one of said vehicle bodies, and said brake device is arranged on one side in the axial direction of each of said speed changing shafts oppositely to said connecting mechanism.
